(19) United States
(12) Patent Application Publication
(10) Pub. No.: US 2009/0172296 A1
(43) Pub. Date: Jul. 2, 2009

(54) Cache Memory System and Cache Memory Control Method

(75) Inventors: Masayuki TSUJI, Kawasaki (JP); Yoshimasa Takebe, Kawasaki (JP); Akira Nodomi, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU MICROELECTRONICS LIMITED, Tokyo (JP)

(21) Appl. No.: 12/343,251

(22) Filed: Dec. 23, 2008

(30) Foreign Application Priority Data
Dec. 26, 2007 (JP) 2007-334496

(51) Int. Cl. G06F 12/08

(52) U.S. Cl. 711/143; 711/E12.026

(57) ABSTRACT

A cache memory system including a processing unit and a cache memory which is connected to the processing unit, wherein when a store instruction of storing write data into a certain address is executed, the cache memory system executes selectively one of, a first operation mode of allocating an area of the address to the cache memory in response to a generation of a cache miss due to an access to the address, copying data of the address of the main memory unit to the cache memory and then rewriting the copied data on the cache memory using the write data, and a second operation mode in response to a generation of a cache miss due to the access to the address and storing the write data to the cache memory without copying data of the address of the main memory unit to the allocated area on the cache memory.

### CROSS-REFERENCE TO RELATED APPLICATIONS

This application is based upon and claims the benefit of priority from the prior Japanese Patent Application No. 2007-334496 filed on Dec. 26, 2007, the entire contents of which are incorporated herein by reference.

### BACKGROUND

1. Field

Aspects of the present invention relate generally to a memory system, and more particularly to a cache memory system.

2. Description of the Related Art

A computer system generally includes a small-capacity, high-speed cache memory as well as a main memory. By copying part of the information stored in the main memory to the cache memory, when an access is made to this information, the information can be read out, not from the main memory, but from the cache memory, thereby achieving high-speed read-out of the information.

The cache memory contains plural cache lines and copying of information from the main memory to the cache memory is carried out in units of the cache line. The memory space of the main memory is divided into cache line units and the divided memory areas are allocated to the cache lines in succession. Because the capacity of the cache memory is smaller than that of the main memory, memory areas of the main memory are allocated to the same cache line repeatedly.

Generally, of all bits of an address, its lower bits of a predetermined number serve as an index of the cache memory while remaining bits located higher than those lower bits serve as a tag of the cache memory. When an access is made to data, the tag of a corresponding index in the cache memory is read out, using the index portion in an address which indicates an access target. It is determined whether or not the read out tag agrees with a bit pattern of the tag portion in the address. If they do not agree, a cache miss occurs. If they agree, a cache hit occurs, so that cache data (data of predetermined bit number of a single cache line) corresponding to the index is accessed.

According to the write through system, when data is written into a memory, a write is made into the main memory at the same time when a write is made to the cache memory. In this system, even if it becomes necessary to replace the content of the cache memory, it is only necessary to invalidate the significant bits which indicate validity/invalidity of the data. Contrary to the write through system, in the write back system, when writing data into the memory, only a write into the cache memory is executed. Because the written data exists only on the cache memory, if the content of the cache memory is replaced, it is necessary to copy the content of the cache memory into the main memory. When a miss-hit is generated, a write allocation system operation and no-write allocation system operation are available. According to the write allocation system, data which is an access target is copied from the main memory into the cache memory and data on the cache memory is updated by a write operation. According to the no-write allocation system, only data which is an access target on the main memory is updated by the write operation without copying data of the main memory into the cache memory.

When a cache miss occurs, a store instruction (write instruction) of the write allocation system prepares a copy of data in the main memory in the cache. Thus, to some extent a penalty is generated in the execution of an instruction by the processor. To reduce the penalty of data transfer by an amount corresponding to a single cache line to the cache memory from the main memory, a preload (pre-fetch) instruction may be used. This preload instruction is issued at an earlier time than the store instruction in which the cache miss is generated by an amount of time required for preparing the copy of the data in the main memory in the cache memory. As a result, the copy of the data in the main memory is prepared in the cache memory while other instruction is being executed after the preload instruction is issued. Therefore, the penalty of the store instruction, when the cache miss is generated, can be hidden.

The penalty of data transfer (move in operation,) by an amount corresponding to a single cache line at the time of the cache miss, can be hidden by issuing the preload instruction preliminarily. Sometimes, data transfer by an amount of a single cache line from the main memory to the cache memory is wasteful. That is, if it is known from the beginning that data of an amount of a single cache line to be copied to the cache memory, in response to the store instruction, is scheduled to be completely rewritten, the transfer of this data from the main memory to the cache memory itself is wasteful. A memory access accompanied by this data transfer is just a wasteful factor which deteriorates processing performance and increases power consumption.

Japanese Patent Application Laid-Open No. 7-210463 has described technology preventing the above-described wasteful data transfer originating from a store instruction of the write allocation system by means of hardware. This technology aims at storing all cache entry data continuously, and requires an additional number of instruction queues and write buffers for detecting the continuous store instruction. If a discontinuous storage operation occurs, for example when a store instruction is dispatched to a plurality of the cache entries successively such as with stride access, it is extremely difficult to prevent the wasteful data transfer.

### SUMMARY

Aspects of an embodiment includes a cache memory system comprising:

a processing unit which functions to access a main memory unit; and

a cache memory which is connected to the processing unit and capable of making an access from the processing unit at a higher speed than the main memory unit,

wherein when a store instruction of storing write data into a certain address is executed, the cache memory system executes selectively:

a first operation mode allocating an area of the address to the cache memory in response to a generation of a cache miss due to an access to the address, copying data of the address of the main memory unit to the allocated area on the cache memory and then rewriting the copied data on the cache memory using the write data; and

a second operation mode allocating the area of the address to the cache memory in response to a generation of a cache miss due to an access to the address and storing the write data to the allocated area on the cache memory without copying data of the address of the main memory unit to the allocated area on the cache memory.

Additional advantages and novel features of aspects of the present invention will be set forth in part in the description that follows, and in part will become more apparent to those skilled in the art upon examination of the following or upon learning by practice thereof.

### BRIEF DESCRIPTION OF THE DRAWINGS

FIG. 1 is a conceptual diagram for explaining the operation of a first embodiment in accordance with aspects of the present invention;

FIG. 2 is a conceptual diagram for explaining the operation of a second embodiment in accordance with aspects of the present invention;

FIG. 3 is a conceptual diagram for explaining the operation of a third embodiment in accordance with aspects of the present invention;

FIG. 4 is a diagram showing the configuration of a cache memory system according to an embodiment in accordance with aspects of the present invention;

FIG. 5 is a flow chart showing aspects of the operation of the first embodiment shown in FIG. 1;

FIG. 6 is a flow chart showing aspects of the operation of the second embodiment shown in FIG. 2;

FIG. 7 is a diagram showing another configuration of the cache memory system according to an embodiment in accordance with aspects of the present invention; and

FIG. 8 is a flow chart showing aspects of the operation of the third embodiment shown in FIG. 3.

### DESCRIPTION OF THE PREFERRED EMBODIMENTS

Hereinafter, embodiments in accordance with aspects of the present invention will be described in detail with reference to the accompanying drawings.

If it is preliminarily known that data of a single cache line to be copied to a cache memory in response to a store instruction will be rewritten completely by that store instruction, transfer of this data from a main memory to the cache memory is wasteful. A data area in which this wasteful data transfer occurs is often determined statistically at the time a program is created. Therefore, a store instruction for executing wasteful data transfer can be recognized with software such as a compiler, and means for preventing the wasteful data transfer can be provided through the software.

According to a first embodiment in accordance with aspects of the present invention, two kinds of store instructions, that is, a first store instruction and a second store instruction, are prepared in a write allocation type cache memory system. The first store instruction is a store instruction that generates worthwhile data transfer, and the second store instruction is a store instruction that generates the wasteful data transfer.

If the store instruction for storing write data into an address is executed, the first store instruction is executed so as to allocate the area of that address to the cache memory in response to a generation of a cache miss due to an access to that address. At the same time, after data of that address in the main memory unit is copied to an allocated area on the cache memory, a first operation mode of rewriting the copied data on the cache memory using write data is executed. Consequently, an ordinary write allocated type store instruction is implemented.

If a store instruction for storing write data into an address is executed, the second store instruction is executed, and the area of that address is allocated to the cache memory in response to a generation of the cache miss due to access to that address. At the same time, a second operation mode of storing write data into an allocated area on the cache memory is executed without copying data of that address of the main memory unit to the allocated area on the cache memory. Consequently, unlike the ordinary write allocate type store instructionstore instruction, the store operation excluding the data transfer (MoveIn) of a single cache line from the main memory unit to the cache memory can be executed.

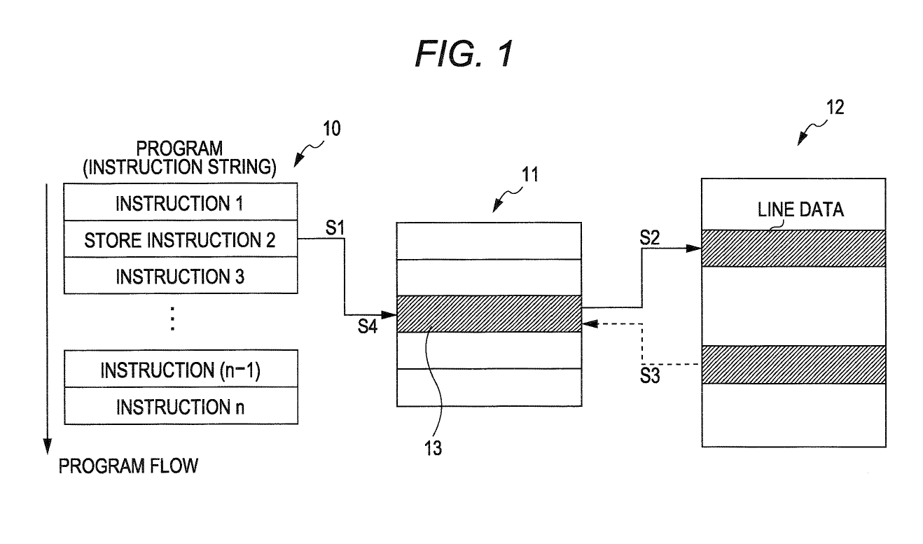

FIG. 1 is a conceptual diagram for explaining the operation of the first embodiment in accordance with aspects of the present invention. In a cache memory system including a processing unit such as a CPU which functions to access the main memory unit 12 and a cache memory 11 capable of being accessed from the processing unit at a higher speed than the main memory unit 12, the processing unit executes a program (instruction string) 10. The program 10 contains instruction 1 to instruction n and, for example, a second instruction is a store instruction.

First, a situation where the store instruction is the first store instruction for executing the MoveIn operation will be described. The CPU (processing unit) fetches, decodes and executes the store instruction. In response to an issue of this store instruction, write data and write address are sent to the cache memory 11 (S1). Assume that at this time, a cache miss occurs because the tag of the cache entry 13 and the write address do not agree with each other. Assume that another cache line data in a dirty state (state in which changes of the cache data are not reflected on the main memory unit 12) exists on a corresponding cache line. In this case, write of the write data to the cache entry 13 is suspended and the write data is stored in a buffer inside the cache memory 11.

After that, a write back operation is executed, writing cache line data stored currently in a target cache entry 13 into the main memory unit 12, in order to replace the cache line data in the target cache entry 13 (S2). Data transfer (MoveIn operation) from the main memory unit 12 to the cache memory 11 is executed in order to copy data of a single cache line, including a specified write address from the main memory unit 12, to the target cache entry 13 of the cache memory 11 (S3). At this time, the tag of the cache entry 13 is rewritten to a tag corresponding to the specified write address and the cache entry 13 of the cache memory 11 is allocated as a write address.

Finally, data of the target cache entry 13 is updated using the write data stored in an internal buffer of the cache memory 11. Consequently, execution of the first store instruction is completed.

Next, a situation where the store instruction is a first store instruction, which does not execute the MoveIn operation, will be described. Sending the write data and write address to the cache memory 11 due to issue of the store instruction (S1) is the same as the case of the first store instruction. Assume that other cache line data in a dirty state (state in which changes of the cache data are not reflected to the main memory unit 12) exists in a corresponding cache line. In this case, a write back operation of writing cache line data stored currently in the target cache entry 13 into the main memory unit 12 is executed, in order to replace the cache line data in the target cache entry 13 (S2). With the second store instruction, unlike the first store instruction, the MoveIn operation of transferring data of a single cache line containing the specified write address from the main memory unit 12 to the target cache entry of the cache memory 11 is not carried out. That is, the data transfer of S3 indicated with dotted line is not executed. The tag of the cache entry 13 is rewritten to a tag corresponding to the specified write address and the cache entry 13 of the cache memory 11 is allocated as the area of the write address.

Finally, data of the target cache entry 13 is updated using the write data held in the internal buffer of the cache memory 11. Consequently, execution of the second store instruction is completed.

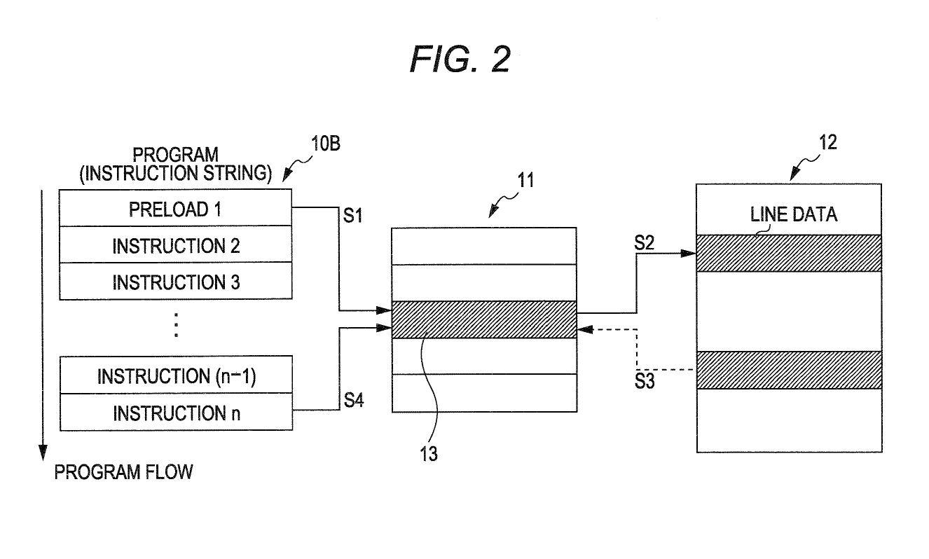

FIG. 2 is a conceptual diagram for explaining the operation of the second embodiment in accordance with aspects of the present invention. In the second embodiment, two kinds of preload instructions, that is, a first preload instruction and a second preload instruction, are prepared in the write allocation type cache memory system. When a store instruction includes data transfer that is not wasteful, the first preload instruction is executed preliminarily, and when the store instruction includes data transfer that is wasteful, the second preload instruction is executed preliminarily.

If the first preload instruction is issued prior to the store instruction, the area of an access target address is allocated in the cache memory in response to generation of a cache miss due to the preload instruction. At the same time, data of that address of the main memory unit is copied to the allocated area on the cache memory. If the second preload instruction is issued prior to the store instruction, the area of an access target address is allocated to the cache memory in response to a cache miss due to the preload instruction. Then, the preload instruction operation is ended without copying data of that address of the main memory unit to the allocated area on the cache memory.

The same components of FIG. 2 as FIG. 1 are referred to with like reference numerals and description thereof is omitted. A program 10B contains instruction 1 to instruction n and, for example, a first instruction is a preload instruction and an n-th instruction is a store instruction.

First, a situation where the preload instruction is the first preload instruction which executes the MoveIn operation will be described. The CPU (processing unit) fetches, decodes and preloads the preload instruction. When this preload instruction is issued, the load address (write address for a following store instruction) is sent to the cache memory 11 (S1). Assume that at this time, the tag of the corresponding cache entry 13 and the load address do not agree with each other so that a cache miss occurs. Further, assume that another cache line data in a dirty state (state in which changes of the cache data are not reflected to the main memory unit 12) exists in the corresponding cache line.

In this case, write back operation of writing cache line data stored currently in a target cache entry 13 into the main memory unit 12 is executed, in order to replace the cache line data in the target cache entry 13 (S2). Data transfer (MoveIn operation) from the main memory unit 12 to the cache memory 11 is executed in order to copy data of a single cache line including a specified write address from the main memory unit 12 to the target cache entry 13 of the cache memory 11 (S3). At this time, the tag of the cache entry 13 is rewritten to a tag corresponding to the specified write address and the cache entry 13 of the cache memory 11 is allocated as a write address. Then, the execution of the first preload instruction is ended.

Finally, the CPU (processing unit) begins to fetch and decode a store instruction and execute the store instruction. When this store instruction is issued, write data and write address are sent to the cache memory 11 (S4). If a cache entry 13 which agrees with the tag exists in the write address, a cache hit occurs and the write data is stored in this corresponding cache entry 13. As a result, the execution of the store instruction is completed.

Next, a situation where the preload instruction is a second preload instruction, which does not execute the MoveIn operation, will be described. The operation (S1) of sending a load address (write address of a following store instruction) to the cache memory 11 by issuing the preload instruction is the same as the case of the first preload instruction. Assume that another cache line data in a dirty state (state in which changes of the cache data are not reflected in the main memory unit 12) exists on a corresponding cache line. In this case, to replace the cache line data of the target cache entry 13, a write back operation of writing the cache line data stored currently in the target cache entry 13 into the main memory unit 12 is executed (S2). In case of the second preload instruction, unlike the case of the first preload instruction, the MoveIn operation of transferring data of a single cache line containing a specified address from the main memory unit 12 to the target cache entry 13 of the cache memory 11 is not executed. That is, the data transfer of S3 indicated with the dotted line is not executed. By rewriting the tag of the cache entry 13 to a tag corresponding to a specified address, the cache entry 13 of the cache memory 11 is allocated as an area of the specified address. As a result, the execution of the second preload instruction is ended.

Finally, the CPU (processing unit) begins to fetch and decode a store instruction and execute the store instruction. When this store instruction is issued, write data and write address are sent to the cache memory 11 (S4). If a cache entry 13 which agrees with the tag exists in the write address, a cache hit occurs and the write data is stored in this corresponding cache entry 13. As a result, the execution of the store instruction is completed.

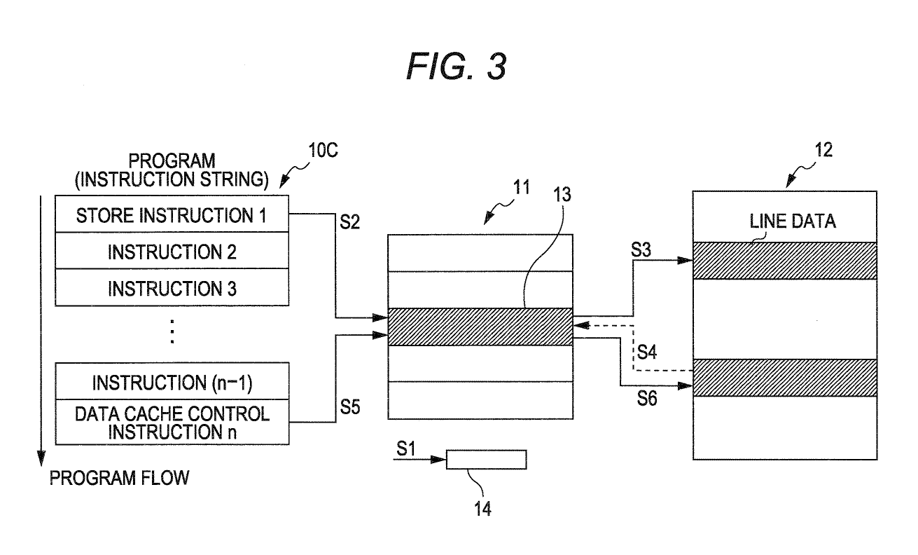

FIG. 3 is a conceptual diagram for explaining the operation of the third embodiment in accordance with aspects of the present invention. The same components of FIG. 3 as FIG. 1 are referred to with like reference numerals and description thereof is omitted. In the third embodiment, if the write allocation type cache memory system further includes a setting register 14 and an area of the cache memory 11 (cache entry 13) corresponding to the write address is set in the setting register 14 as an effective value, the MoveIn operation is executed in response to the preload instruction or the store instruction. Unless the area of the cache memory 11 (cache entry 13) corresponding to the write address is set in the setting register 14 as an effective value, the MoveIn operation is not executed in response to the preload instruction or store instruction. FIG. 3 shows a case of store instruction, and the same procedure is also taken for the preload instruction. A program 10C of FIG. 3 contains instruction 1 to instruction n and for example, a first instruction is a store instruction while an n-th instruction is a release instruction.

A situation where the MoveIn operation is executed while the store instruction is being executed will be described. First, a predetermined instruction by the CPU is executed so as to release (invalidate) the setting register 14, so that a set value of the setting register 14 is not valid (S1). This can be achieved by providing the setting register 14 with a valid/invalid bit or the like and setting a value indicating invalidity to this bit.

After that, the CPU (processing unit) begins to fetch and decode a store instruction and execute the store instruction. In response to the issue of this store instruction, the write data and write address are sent to the cache memory 11 (S2). Assume that at this time, the tag of the corresponding cache entry 13 does not agree with the write address, and a cache miss occurs. Further assume that another cache line data in a dirty state (state in which changes of the cache data are not reflected in the main memory unit 12) exists in the corresponding cache line. In this case, the write of the write data into the cache entry 13 is suspended and the write data is held in a buffer inside the cache memory 11.

After that, to replace the cache line data of the target cache entry 13, a write back operation of writing the cache line data stored currently in the target cache entry 13 into the main storage unit 12 is executed (S3). To copy data of a single cache line containing a specified write address from the main memory unit 12 to the target cache entry 13 of the cache memory 11, data transfer (MoveIn operation) from the main memory unit 12 to the cache memory 11 is executed (S4). At this time, by rewriting the tag of the cache entry 13 to a tag corresponding to the specified write address, the cache entry 13 of the cache memory 11 is allocated as an area of the write address.

Finally, data of the target cache entry 13 is updated with the write data suspended in an internal buffer of the cache memory 11. As a result, the execution of the store instruction is completed.

Next, a situation where no MoveIn operation is executed when the store instruction is executed will be described. First, the CPU executes a predetermined instruction so as to set a value indicating the cache entry 13 in the setting register 14 and further validate the setting value of the setting register 14 (S1). This can be achieved by setting the valid/invalid bit or the like in the setting register 14 and then setting a value indicating validity in this bit.

An operation of sending the write data and write address to the cache memory 11 when the store instruction is issued (S2) is the same as the case of the first store instruction. Assume that another cache line data in a dirty state (state in which changes of the cache data are not reflected to the main memory unit 12) exists in the corresponding cache line. In this case, to replace the cache line data of the target cache entry 13, a write back operation of writing the cache line data stored currently in the target cache entry 13 into the main memory unit 12 is executed (S3). If the setting register 14 indicates the cache entry 13, no MoveIn operation of transferring data of a single cache line containing the specified write address from the main memory unit 12 to the target cache entry 13 of the cache memory 11 is executed. That is, the data transfer of S4 indicated with the dotted line is not executed. By rewriting the tag of the cache entry 13 to a tag corresponding to the specified write address, the cache entry 13 of the cache memory 11 is allocated as an area of the write address.

After that, data of the target cache entry 13 is updated with the write data suspended in the internal buffer of the cache memory 11. Consequently, the execution of the store instruction is completed.

Finally, a data cache control instruction or a register release instruction is issued to release the setting register 14 of the cache memory 11 to invalidate the setting value of the setting register 14. This can be achieved by providing the setting register 14 with a valid/invalid bit or the like and then setting a value which invalidates this bit. As a result, the cache entry 13 can be used as an ordinary cache area. In the meantime, because the cache line data of the cache entry 13 is in a dirty state (that is, a state in which changes of the cache data are not reflected in the main memory unit 12), a write back operation of writing this cache line data into the main memory unit 12 may be executed together with the release operation of the setting register 14 (S6).

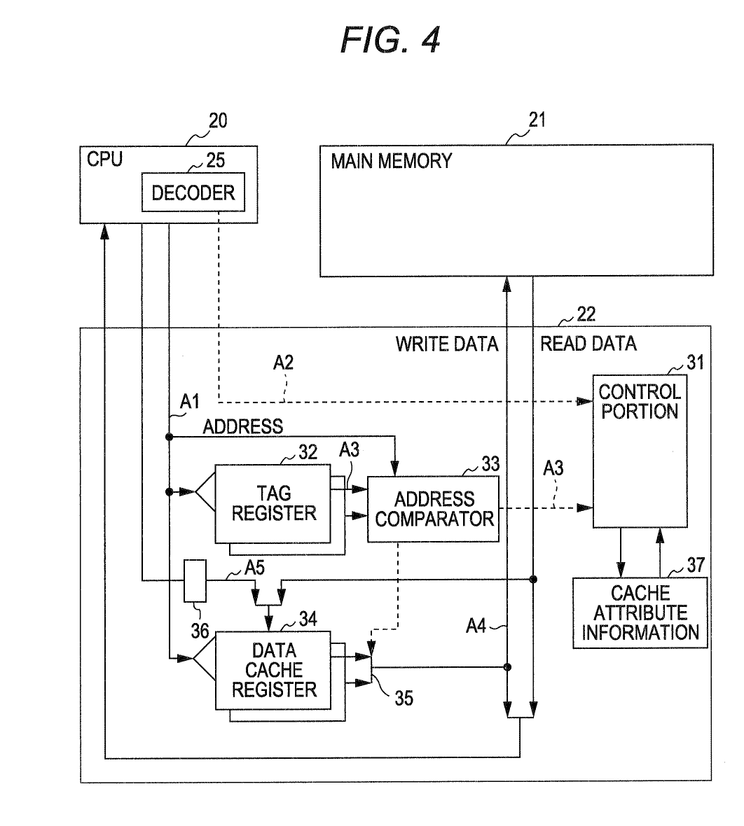

FIG. 4 is a diagram showing the configuration of the cache memory system according to an embodiment in accordance with aspects of the present invention. The cache memory system of FIG. 4 includes a CPU 20, a main memory unit 21, and a cache memory 22. The memory system may be formed in an hierarchical structure. For example, a memory unit that is a higher level memory layer located higher than the main memory unit 21 may be provided between the main memory unit 21 and the cache memory 22. Likewise, a memory unit that is a higher level memory layer located higher than the cache memory 22 may be provided between the CPU 20 and the cache memory 22.

The cache memory 22 includes a control portion 31, a tag register 32, an address comparator 33, a data cache register 34, a selector, a data buffer 36, and a cache attribute information register 37. The tag register 32 stores an indication of a valid bit, a dirty bit and a tag. The data buffer 36 stores data of a single cache line corresponding to each cache entry. The configuration of the cache memory 22 may be of a direct mapping type in which each cache line is provided with only one tag or of an N-way set associative type in which each cache line is provided with N tags. The N-way set associative type is provided with plural sets of the tag registers 32 and the data cache registers 34.

When the CPU 20 issues (starts to execute) an instruction for accessing a memory space, an address indicating an access target is output from the CPU 20. An index portion of the address indicating this access target is supplied to the tag register 32. The tag register 32 selects a content (tag) corresponding to that index and outputs it. Whether or not the tag output from the tag register 32 agrees with the bit pattern of the tag portion in the address supplied from the CPU 20 is determined by the address comparator 33. If a comparison result indicates an agreement and the significant bit of the index of the tag register 32 is an effective value “1”, a cache hit occurs, so that a signal indicating address agreement is asserted from the address comparator 33 to the control portion 31.

Of the address indicating an access target supplied from the CPU 20, its index portion is supplied to the data cache register 34. The data cache register 34 selects data of a cache line corresponding to that index and outputs it. For the N-way set associative type, the selector 35 selects a single access target from the plural cache line data based on a signal supplied from the address comparator 33 and outputs it. Data output from the selector 35 is supplied to the CPU 20 as data read out from the cache memory 22.

If no access target data exists in the cache memory 22, that is, a cache miss occurs, the address comparator 33 asserts an output indicating that the address disagrees. As a basic operation of this case, the control portion 31 accesses that address of the main memory unit 21 and registers data read out from the main memory unit 21 as a cache entry. That is, data read out from the main memory unit 21 is stored in the data cache register 34. At the same time, a corresponding tag is stored in the tag register 32 and further, a corresponding significant bit is validated. However, aspects of the present invention may include embodiments having an operation mode which does not execute data transfer (MoveIn operation) from the main memory unit 21 to the cache memory 22 even if a cache miss occurs, as described later.

The control portion 31 executes various control operations for cache control. The control operations include setting of the significant bit, setting of the tag, retrieval of available cache line by checking the significant bit, selection of a replacement target cache line based on for example, least recently used (LRU) algorithm or the like and control of data write operation into the data cache register 34. Further, the control portion 34 controls data read-out/write with respect to the main memory unit 21.

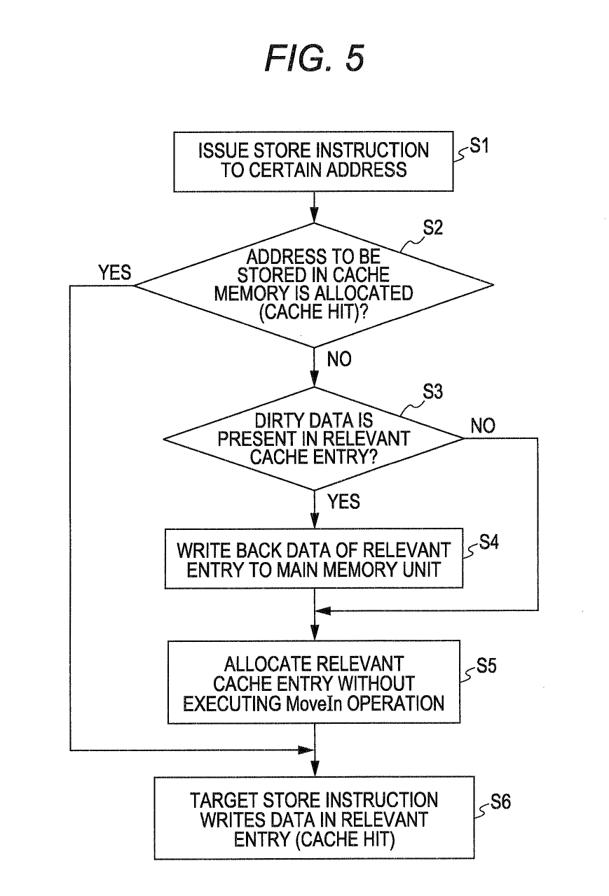

FIG. 5 is a flow chart showing aspects of the operation of the first embodiment shown in FIG. 1. These aspects of the operation of the first embodiment will be described with reference to FIGS. 4 and 5.

In step S1 of FIG. 5, an address of a storage destination is specified and a store instruction is issued. Consequently, an address is supplied to the cache memory 22 from the CPU 20 in FIG. 4 (A1). Write data is supplied from the CPU 20 to the cache memory 22 and stored in the data buffer 36. At the same time, a signal which specifies execution/non-execution of the MoveIn operation is supplied to the control portion 31 of the cache memory 22 from the CPU 20 (A2). More specifically, the decoder 25 of the CPU 20 decodes an execution target instruction so as to determine whether the execution target instruction is a first store instruction accompanied by the MoveIn operation or a second store instruction not accompanied by the MoveIn operation. Based on this determination result, an instruction is dispatched from the CPU 20 to the control portion 31.

In step S2 of FIG. 5, a determination is made as to whether or not the address of the storage destination has been allocated to the cache memory 22. This corresponds to address comparator 33's comparing the tag portion of an access target address with the tag of a corresponding cache entry so as to assert a signal indicating address agreement or a signal indicating address disagreement in response to a comparison result in FIG. 4 (A3). If the allocation is completed, that is, the tags agree with each other, the write data to be stored is written into the corresponding cache entry in step S6 of FIG. 5. That is, in FIG. 4, the write data supplied together with the store instruction is stored in a corresponding cache entry of the data cache register 34 through the data buffer 36 (A5).

If the result of the determination of step S2 of FIG. 5 indicates that the allocation is not completed, that is, the tags do not agree with each other, a determination is made as to whether or not dirty data exists in the corresponding cache entry in step S3 of FIG. 5. This is achieved by determining whether the dirty bit of the corresponding cache entry of the tag register 32 is set to validity or invalidity. If any dirty data exists, data of the corresponding cache entry is written back to the main memory in step S4 of FIG. 5. That is, in FIG. 4, data of the corresponding cache entry of the data cache register 34 is written into the corresponding address of the main memory unit 21 (A4). If no dirty data exists, step S4 is skipped.

Next, in step S5 of FIG. 5, the corresponding cache entry is allocated as an area of the write address. FIG. 5 shows a situation where the second store instruction without the MoveIn operation is executed and only the allocation operation is executed without the MoveIn operation. This corresponds to rewriting the tag of the corresponding cache entry of the tag register 32 to a tag corresponding to the write address in FIG. 4. If the first store instruction accompanied by the MoveIn operation is executed, data of the cache line read out from the corresponding address of the main memory unit 21 is written into the corresponding cache entry of the data cache register 34 and further, the tag of the corresponding cache entry of the tag register 32 is rewritten to a tag corresponding to the write address.

After that, in step S6 of FIG. 5, the write data is written into the corresponding cache entry according to the store instruction. That is, in FIG. 4, the write data supplied together with the store instruction is stored in the corresponding cache entry of the data cache register 34 through the data buffer 36 (A5).

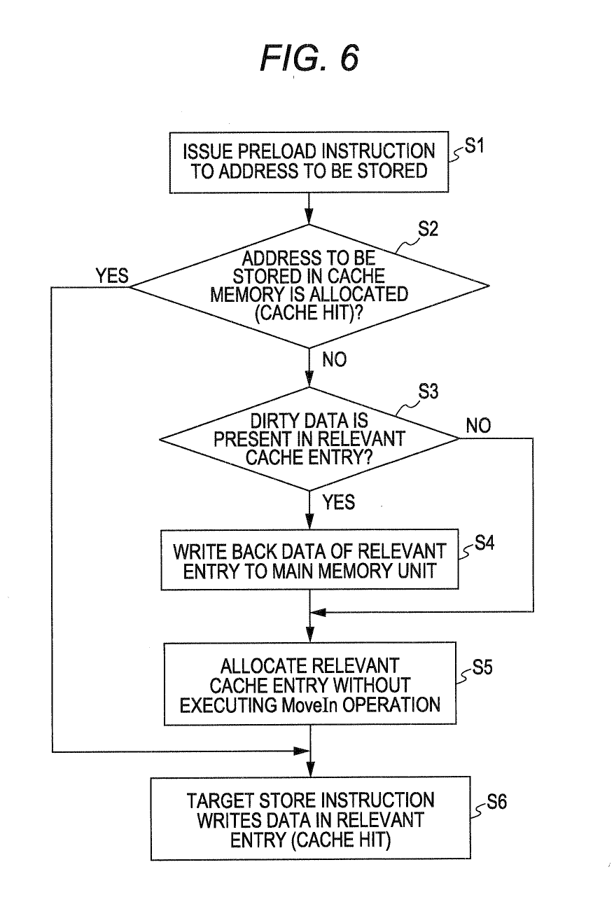

FIG. 6 is a flow chart showing the operation of aspects of the second embodiment shown in FIG. 2. The operation of these aspects of the second embodiment will be described with reference to FIGS. 4 and 6.

In step S1 of FIG. 6, a loading destination address (write address of a following store instruction) is specified and a preload instruction is issued. Consequently, in FIG. 4, the CPU 20 supplies an address to the cache memory 22 (A1). At the same time, the CPU 20 supplies a signal which specifies execution/non-execution of the MoveIn operation to the control portion 31 of the cache memory 22 (A2). More specifically, the decoder 25 of the CPU 20 decodes an execution target instruction, so as to determine whether the execution target instruction is a first preload instruction with the MoveIn operation or a second preload instruction without the MoveIn operation. Based on this determination result, an instruction is dispatched from the CPU 20 to the control portion 31. FIG. 6 is a flow chart showing an operation when the second preload instruction is issued.

After that, the same operation as from step S2 to step S5 of FIG. 5 is executed as step S2 to step S5 of FIG. 6 according to the issued second preload instruction. Although in FIG. 5, step S2 to step S5 are executed according to the store instruction, step S2 to step S5 of FIG. 6 are executed according to the preload instruction. Finally, in step S6 of FIG. 6, the store instruction is issued after the preload instruction so as to write the write data into the corresponding cache entry according to the store instruction. That is, in FIG. 4, the write data supplied together with the store instruction is stored in the corresponding cache entry of the data cache register 34 through the data buffer 36 (A5).

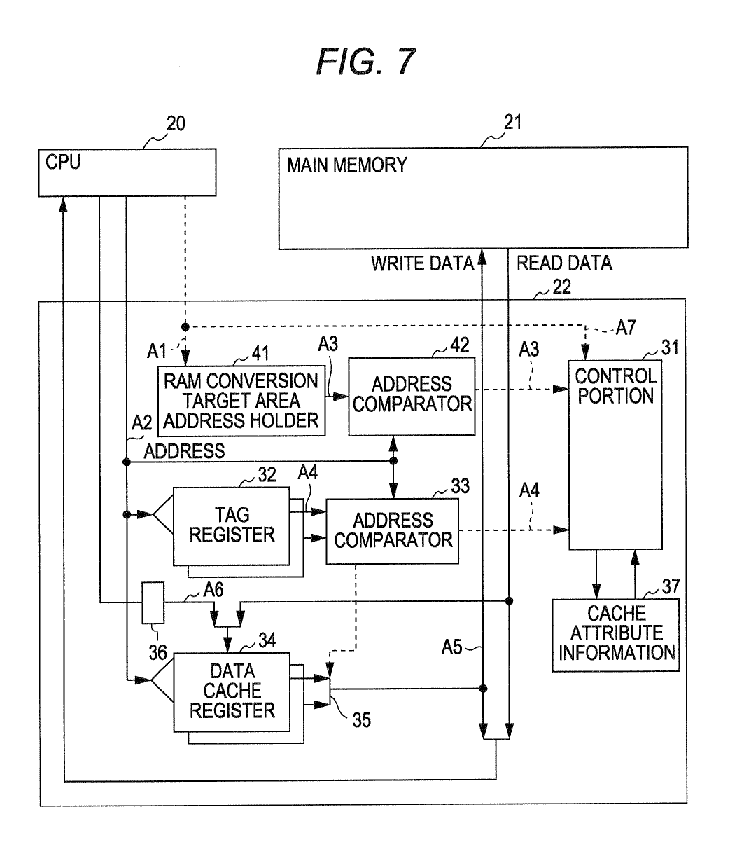

FIG. 7 is a diagram showing another configuration of the cache memory system according to an embodiment in accordance with aspects of the present invention. The same components in FIG. 7 as FIG. 4 are referred to with like reference numerals and description thereof is omitted. The cache memory system of FIG. 7 further includes a RAM conversion target area address holding register 41 and an address comparator 42 in the cache memory 22, in addition to the configuration of the cache memory system shown in FIG. 4. The RAM conversion target area address holding register 41 is a register corresponding to the setting register 14 of FIG. 3, which stores the address of an accessible area without any MoveIn operation. Because a feature of the accessible area without any MoveIn operation is similar to the feature of the memory area of the RAM which can be accessed without any procedure, the term “RAM conversion target” is used here. That is, the cache entry converted to the RAM is accessed without any MoveIn operation. The address comparator 42 compares the address of an accessing target supplied from the CPU 20 with an address to be stored in the RAM conversion target area address holding register 41 and supplies a signal indicating a comparison result of agreement/disagreement to the control portion 31.

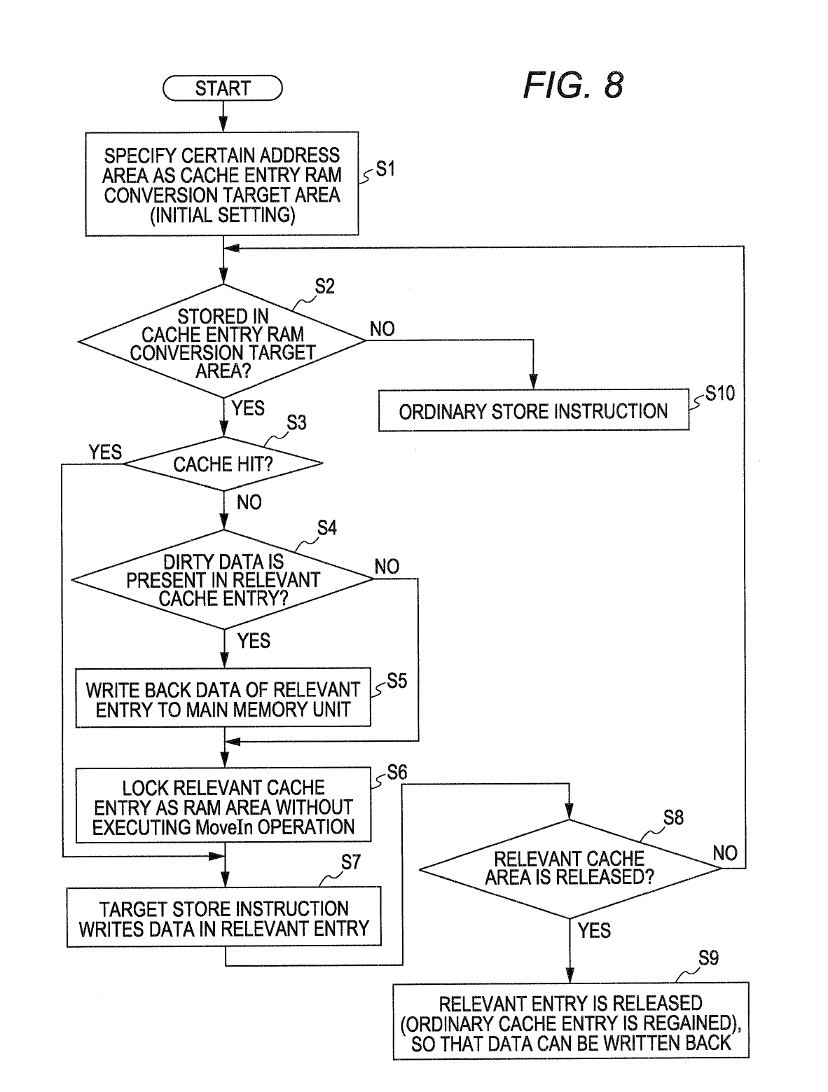

FIG. 8 is a flow chart showing the operation of aspects of the third embodiment shown in FIG. 3. These aspects of the operation of the third embodiment will be described with reference to FIGS. 7 and 8. Although FIG. 8 describes an exemplary situation for the store instruction, the same operation can be executed for the preload instruction, also.

In step S1 of FIG. 8, a desired address area (cache entry) is specified as a RAM conversion target area. That is, in FIG. 7, the CPU 20 supplies the address of a desired cache entry of RAM conversion target into the RAM conversion target area address holding register 41 of the cache memory 22 and stores this address in the RAM conversion target area address holding register 41 (A1). If there is a store instruction intended to eliminate the execution of the wasteful MoveIn operation, this desired address area is an area corresponding to the write address for this store instruction.

In step S2 of FIG. 8, a determination is made as to whether or not an issued store instruction is for storage into the RAM conversion target area of the cache entry. If a store instruction is issued by specifying a storage destination address in FIG. 7, the address is supplied from the CPU 20 to the cache memory 22 (A2). The address comparator 42 compares an address stored in the RAM conversion target address holding register 41 with an address supplied from the CPU 20 and supplies a signal indicating address agreement/disagreement to the control portion 31 (A3). When the aforementioned store instruction is issued, tile CPU 20 supplies the cache memory 22 with write data and the write data is stored in the data buffer 36.

If the result of step S2 of FIG. 8 is NO, the ordinary store instruction is executed in step S10. If a cache miss occurs, the MoveIn operation is executed and data of the cache entry is rewritten with the write data. If the result of step S2 in FIG. 8 is YES, in step S3, a determination is made as to whether or not a storage destination address has been allocated to the cache memory 22. This corresponds to address comparator 33's comparing the tag portion of an access target address with the tag of a corresponding cache entry and asserting a signal indicating address agreement or a signal indicating address disagreement in response to a comparison result in FIG. 7 (A4). If the allocation is completed, that is, the tags agree with each other, storage target write data is written into the corresponding cache entry in step S7 of FIG. 8. That is, in FIG. 7, the write data supplied together with the store instruction is stored in the corresponding cache entry of the data cache register 34 through the data buffer 36 (A6).

If the result of the determination of step S3 of FIG. 8 indicates that the allocation has not been completed, that is, the tags do not agree with each other, a determination is made as to whether or not any dirty data exists in the corresponding cache entry in step S4 of FIG. 8. This is executed by determining whether the dirty bit of the corresponding cache entry of the tag resister 32 is set to valid or invalid. If there is any dirty data, data of the corresponding cache entry is written back to the main memory in step S5 of FIG. 8. That is, in FIG. 7, data of the corresponding cache entry of the data cache register 34 is written into the corresponding address of the main memory unit 21 (A5). If there is no dirty data, step S5 is skipped.

Next, in step S6 of FIG. 8, the corresponding cache entry is locked as a RAM area without executing any MoveIn operation. That is, the corresponding cache entry is allocated as an area of the write address. This corresponds to rewriting the tag of the corresponding cache entry of the tag register 32 to a tag corresponding to the write address in FIG. 7. After that, in step S7 of FIG. 8, the write data is written into the corresponding cache entry according to a store instruction. That is, the write data supplied together with the store instruction is stored in the corresponding cache entry of the data cache register 34 through the data buffer 36 in FIG. 7 (A6).

In step S8 of FIG. 8, a determination is made as to whether or not the RAM conversion target area of the cache entry is released. If not, the procedure is returned to step S2, in which the following processing (execution processing of a next instruction) is carried out. If the RAM conversion target area is released, in step S9, the RAM conversion target area of the cache entry is released to be usable as an ordinary cache entry. At this time, data of the cache entry may be written back (write operation to the main memory unit 21 to reflect data change). In FIG. 7, a store address for the RAM conversion target address holding register 41 is instructed to be set as an invalid value from the CPU 20 to the RAM conversion target address holding register 41 and/or the control portion 31 (A7).

Exemplary embodiments in accordance with aspects of the present invention have been described above and the present invention is not restricted to the above embodiments but may be modified in various ways within a range described in the scope of claims of the invention. It will be appreciated that these examples are merely illustrative of aspects of the present invention. Many variations and modifications will be apparent to those skilled in the art.

What is claimed is:

1. A cache memory system comprising:
a main memory unit;
a processing unit for accessing the main memory unit; and
a cache memory connected to the processing unit and capable of being accessed by the processing unit at a higher speed than the main memory unit,
wherein when a store instruction of storing write data into a certain address is executed, the cache memory system executes selectively one of:
a first operation mode for allocating an area of the address to the cache memory in response to a generation of a cache miss due to the access to the address, copying data of the address of the main memory unit to the allocated area on the cache memory, and then, rewriting the copied data on the cache memory using the write data; and
a second operation mode for allocating the area of the address to the cache memory in response to the generation of a cache miss due to the access to the address and storing the write data to the allocated area on the cache memory, without copying data of the address of the main memory unit to the allocated area on the cache memory.

2. The cache memory system according to claim 1, wherein when a preload instruction is issued prior to the store instruction,
if the cache memory system executes the first operation mode, the area of the address is allocated to the cache memory, in response to the generation of a cache miss due to the preload instruction, and data of the address of the main memory unit is copied to the allocated area on the cache memory, and
if the cache memory system executes the second operation mode, the area of the address is allocated to the cache memory, in response to the generation of a cache miss due to the preload instruction, and data of the address of the main memory unit is not copied to the allocated area on the cache memory.

3. The cache memory system according to claim 2, wherein the first operation mode is executed by the cache memory system in response to a first preload instruction which specifies the execution of the first operation mode, and
the second operation mode is executed by the cache memory system in response to a second preload instruction which specifies the execution of the second operation mode.

4. The cache memory system according to claim 1, wherein when the store instruction is issued,
if the cache memory system executes the first operation mode, the area of the address is allocated to the cache memory, in response to the generation of a cache miss due to the store instruction, and data of the address on the main memory unit is copied to the allocated area on the cache memory and the copied data on the cache memory is rewritten with the write data, and
if the cache memory system executes the second operation mode, the area of the address is allocated to the cache memory, in response to the generation of the cache miss due to the store instruction, and the write data is stored in the allocated area on the cache memory without copying the data of the address of the main memory unit to the allocated area on the cache memory.

5. The cache memory system according to claim 4, wherein the first operation mode is executed by the cache memory system in response to a first store instruction which specifies the execution of the first operation mode, and
the second operation mode is executed by the cache memory system in response to a second store instruction which specifies the execution of the second operation mode.

6. The cache memory system according to claim 1, further comprising a register, wherein
when the area of the cache memory, corresponding to the address, is set in the register as a significant value, the first operation mode is executed, and
when the area of the cache memory, corresponding to the address, is not set in the register as a significant value, the second operation mode is executed.

7. The cache memory system according to claim 6, wherein the setting of the significant value in the register is released in response to a predetermined instruction.

8. The cache memory system according to claim 1, wherein, if the cache memory system executes one of the first operation mode and the second operation mode, when the area of the address is allocated to the cache memory, data of another address, already existing in the area, is transferred from the cache memory to the main memory unit.

9. A control method for executing a store instruction for storing data in a particular address in a cache memory system containing a processing unit which functions to access a main memory unit and a cache memory, which cache memory is connected to the processing unit and is capable of accessing data from the processing unit at a higher speed than the main memory unit, the control method comprising the steps of:
allocating an area of the address in the cache memory in response to a generation of a cache miss due to an access to the address; and
storing write data in the allocated area on the cache memory without copying the data of the address of the main memory unit in the allocated area on the cache memory.

10. The control method according to claim 9, further comprising:
transferring data of another address already existing in the area from the cache memory to the main memory unit, when allocating the area of the address, wherein
the step of transferring data to the main memory unit and the step of allocating the area of the address are executed based on a preload instruction that is dispatched ahead of the store instruction.
